(19) United States
(12) Patent Application Publication
(10) Pub. No.: US 2007/0007872 A1
(43) Pub. Date: Jan. 11, 2007

(54) Field emission device (FED) having ring-shaped emitter and its method of manufacture

(76) Inventors: Young-Jun Park, Suwon-si (KR); Ha-Jin Kim, Suwon-si (KR)

Correspondence Address: Robert E. Bushnell, Suite 300, 1522 K Street, N.W., Washington, DC, 20005, US

(21) Appl. No.: 11/449,737

(22) Filed: Jun. 9, 2006

(30) Foreign Application Priority Data
Jul. 9, 2005 (KR) 10-2005-0061948

(51) Int. Cl. H01J 1/14; H01J 19/06; H01K 1/04

(52) U.S. Cl. 313/346 R

(57) ABSTRACT

A Field Emission Device (FED) having a ring-shaped emitter and its method of manufacture includes a ring-shaped emitter formed on a cathode exposed through an aperture of a gate electrode, has a shape corresponding to a shape of the aperture of the gate electrode, and has carbon nanotubes on edges thereof. The ring-shaped emitter is formed through an annealing process that controls the diffusion of a catalyst metal and silicon between a catalyst metal layer and a silicon layer.

### CLAIM OF PRIORITY

This application makes reference to, incorporates the same herein, and claims all benefits accruing under 35 U.S.C. § 119 from an application for FIELD EMISSION DEVICE AND ITS FABRICATION METHOD WITH RING TYPE EMITTER earlier filed in the Korean Intellectual Property Office on the 9^{th} of Jul. 2005 and there duly assigned Serial No. 10-2005-0061948.

### BACKGROUND OF THE INVENTION

1. Field of the Invention

The present invention relates to a Field Emission Device (FED) having a ring-shaped emitter and its method of manufacture, and more particularly, to a three-electrode FED in which carbon nanotubes of an emitter are arranged at approximately uniform distances from a gate electrode and a method of manufacturing such a three-electrode FED.

2. Description of the Related Art

Generally, a three-electrode Field Emission Device (FED) consists of an anode, a cathode, and a gate electrode. An emitter for emitting electrons is provided on the cathode. The gate electrode is located close to the emitter and forms a strong electric field to cause the emission of electrons from the emitter. An electric field is formed between the anode and the cathode to induce the emitted electrons.

Carbon nanotubes are considered a useful electron emission source of an FED, i.e., an emitter, and have very high electrical conductivity and a high aspect ratio. Methods of growing the carbon nanotubes include a thermal Chemical Vapor Deposition (CVD) method, an arc discharge method, a laser ablation method, and a plasma enhanced CVD method.

In the thermal CVD method, carbon nanotubes are grown vertically from a surface of a catalyst metal layer by injecting a carbon containing gas, such as CH₄, C₂H₂, C₂H₄, C₂H₆, CO, or CO₂, together with H₂, N₂, or Ar into a reactor, a temperature of which is held at 500 to 900° C., after the catalyst metal layer is formed on a surface of an electrode formed on a substrate. The plasma enhanced CVD method is also used for growing carbon nanotubes using a catalyst metal.

However, when carbon nanotubes for manufacturing an emitter of an FED are grown only using the above mentioned methods, it is difficult to control the density of carbon nanotubes at the surface of the catalyst metal. Also, it is difficult to form a pattern of carbon nanotubes on the emitter. This is because when the catalyst metal itself is patterned, the alignment of a mask and the emitter requires a lot of time and effort.

### SUMMARY OF THE INVENTION

The present invention provides a Field Emission Device (FED) having a structure in which the distances between carbon nanotubes and a gate electrode are approximately uniform by selectively growing the carbon nanotubes only on an edge region of an emitter and a method of manufacturing the FED.

According to one aspect of the present invention, a Field Emission Device (FED) is provided including: a ring-shaped emitter; a front substrate and a rear substrate; an anode arranged on a lower surface of the front substrate; and a cathode and a gate electrode arranged on an upper surface of the rear substrate; the ring-shaped emitter, arranged on a portion of the cathode exposed by an aperture of the gate electrode, has a shape corresponding to a shape of the aperture of the gate electrode and has carbon nanotubes arranged on edges thereof.

The aperture of the gate electrode and the ring-shaped emitter are preferably concentric.

The ring-shaped emitter preferably includes a silicon layer, a buffer layer, and a catalyst metal layer sequentially stacked on the cathode, and catalyst metal silicide domains arranged on a central portion of the catalyst metal layer by diffusion between the silicon layer and the catalyst metal layer.

The catalyst metal layer preferably includes at least one metal or an alloy thereof selected from a group of metals consisting of Ni, Fe, Co, Pt, Mo, W, Y, Au, and Pd. The buffer layer preferably includes at least one metal or an alloy thereof selected from a group of metals consisting of Ti, TiN, Al, Cr, Nb, and Cu. The silicon layer preferably includes amorphous silicon.

According to another aspect of the present invention, a method of manufacturing a Field Emission Device (FED) is provided, the method including: forming a cathode having a silicon layer on an upper surface thereof, a gate insulating layer covering the cathode, and a gate electrode covering the gate insulating layer on a rear substrate; forming a well in the gate electrode and the gate insulating layer to expose the silicon layer; forming an emitter block having a shape corresponding to a shape of the aperture of the gate electrode on the silicon layer in the well by sequentially stacking a buffer layer and a catalyst metal layer on the silicon layer exposed in the well; forming catalyst metal silicide domains on a central portion of the emitter block by annealing the rear substrate to promote diffusion between the silicon layer and the catalyst metal layer; and forming a ring-shaped carbon nanotube emitter by growing carbon nanotubes on edges of an upper surface of the emitter block.

The silicon layer is preferably formed of amorphous silicon. The catalyst metal layer is preferably formed of at least one metal or an alloy thereof selected from a group of metals consisting of Ni, Fe, Co, Pt, Mo, W, Y, Au, and Pd. The catalyst metal layer is preferably formed to have a thickness in a range of 0.5 to 10 nm. The buffer layer is preferably formed of at least one metal or an alloy thereof selected from a group of metals consisting of Ti, TiN, Al, Cr, Nb, and Cu. The buffer layer is preferably formed to have a thickness in a range of 1 to 10 nm.

The buffer layer and the catalyst metal layer are preferably formed by either a magnetron sputtering method or an electron beam evaporation method. The annealing is preferably performed by an infrared ray heating method in a vacuum atmosphere. The annealing is preferably performed at a temperature in a range of 450 to 500° C. for a time period in a range of 5 to 60 minutes.

The catalyst metal layer is preferably formed of at least one metal or an alloy thereof selected from a group of metals consisting of Ni, Fe, Co, Pt, Mo, W, Y, Au, and Pd; the catalyst metal layer preferably has a thickness in a range of 0.5 to 10 nm; the buffer layer is preferably formed of at least one metal or an alloy thereof selected from a group of metals consisting of Ti, TiN, Al, Cr, Nb, and Cu; the buffer layer preferably has a thickness in a range of 1 to 10 nm; and the annealing is preferably performed at a temperature in a of range 450 to 500° C. for a time period in a range of 5 to 60 minutes.

The carbon nanotubes are preferably grown by either a thermal Chemical Vapor Deposition (CVD) method or a plasma enhanced CVD method. The carbon nanotubes are alternatively preferably grown by an infrared ray heating method.

### BRIEF DESCRIPTION OF THE DRAWINGS

A more complete appreciation of the present invention, and many of the attendant advantages thereof, will be readily apparent as the present invention becomes better understood by reference to the following detailed description when considered in conjunction with the accompanying drawings in which like reference symbols indicate the same or similar components, wherein:

FIG. 1 is a Scanning Electron Microscope (SEM) image of a three-electrode Field Emission Device (FED) having a carbon nanotube emitter;

FIG. 2 is a perspective view of an FED having a ring-shaped emitter according to an embodiment of the present invention;

FIG. 3 is a graph of bonding energies of catalyst metal layers after a thermal Chemical Vapor Deposition (CVD) method is performed using Fe as a catalyst metal;

FIG. 4 is a SEM image showing that carbon nanotubes are not grown by a CVD method when a diffusion barrier is not included between a catalyst metal layer and a silicon layer;

FIG. 5 is a SEM image of carbon nanotubes grown using a CVD method without annealing when a diffusion barrier is included between a catalyst metal layer and a silicon layer;

FIGS. 6A through 6C are cross-sectional views of a method of growing carbon nanotubes by diffusion control according to an embodiment of the present invention;

FIGS. 7 and 8 are graphs of component distributions according to depth from the surface of a substrate respectively annealed at temperatures of 480° C. and 500° C. while sputtering;

FIGS. 9A through 9D are cross-sectional views of a method of manufacturing an FED according to an embodiment of the present invention;

FIG. 10 is a SEM image of a cut-away FED according to an embodiment of the present invention;

FIG. 11 is a magnified SEM image of a region E of FIG. 10; and

FIG. 12 is a photograph of a uniformity test of a flat panel display device that uses an FED according to an embodiment of the present invention.

### DETAILED DESCRIPTION OF THE INVENTION

The present invention is described more fully below with reference to the accompanying drawings in which exemplary embodiments of the invention are shown. Like reference numerals refer to like elements throughout the drawings, and thus, descriptions of elements that have been described previously have not been repeated.

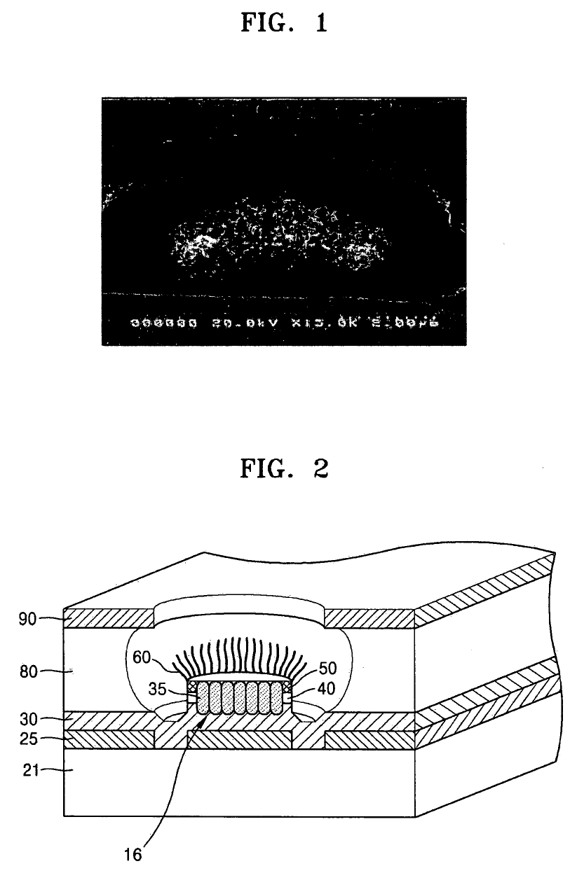

FIG. 1 is a Scanning Electron Microscope (SEM) image of a three-electrode Field Emission Device (FED) having a carbon nanotube emitter. A cathode is formed on a rear substrate, a gate electrode is formed on the cathode while interposing a gate insulating layer therebetween, and a carbon nanotube emitter is formed on the cathode exposed on a bottom of a well formed in the gate electrode and the gate insulating layer. Carbon nanotubes are grown from a surface of a catalyst metal using a Chemical Vapor Deposition (CVD) method, and usually, the carbon nanotubes are evenly distributed on the surface of the catalyst metal.

However, as depicted in FIG. 1, when the carbon nanotubes are not evenly distributed on the emitter, electrons emitted from the emitter have substantially different energy levels since the distance between an end of each of the carbon nanotubes to the gate electrode is not uniform. For this reason, uniform control of electron beams can be difficult.

FIG. 2 is a perspective view of an FED having a ring-shaped emitter 16 according to an embodiment of the present invention. A cathode 25 is formed on an upper surface of a rear substrate 21, and a silicon layer 30, a gate insulating layer 80, and a gate electrode 90 are stacked on the cathode 25. The ring-shaped emitter 16 has ring-shaped carbon nanotubes 60 located on an edge region of a surface of an emitter block protruding from a bottom of a well formed in an aperture of the gate electrode 90. The aperture of the gate electrode 90 has approximately the same shape as the ring-shaped emitter 16. For example, in a plan view of the FED of FIG. 2, the aperture of the gate electrode 90 and the ring-shaped emitter 16 form concentric circles. This enables the carbon nanotubes 60 located on the edge region of the emitter to have a uniform distance from an edge of the aperture of the gate electrode 90.

The ring-shaped emitter 16 has a vertical structure in which the silicon layer 30, a buffer layer 40, and a catalyst metal layer 50 are sequentially stacked, and a silicide domain 35 of a catalyst metal is formed on a central portion of the vertical structure except for the edge region where the carbon nanotubes 60 are located. The silicide domain 35 of a catalyst metal is formed by inter-diffusion between the catalyst metal layer 50 and the silicon layer 30.

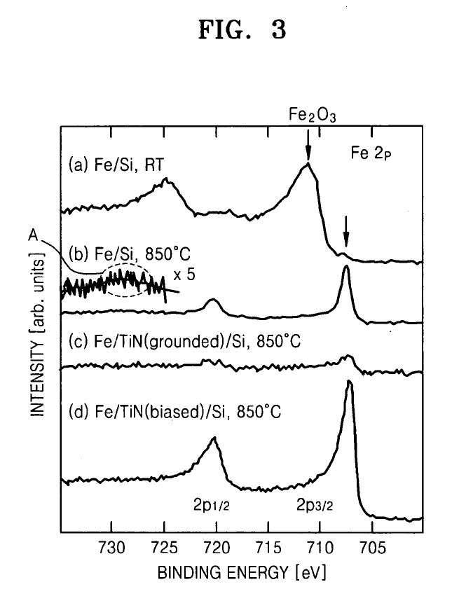

FIG. 3 is a graph of bonding energies of catalyst metal layers after a thermal CVD method is performed using Fe as the catalyst metal. In the case of (b), i.e., when a high temperature CVD method is performed at a temperature of 850° C. after Fe is deposited on a silicon layer, unlike the case (a), i.e., when the silicon layer with an Fe deposition is placed at room temperature (RT), a peak appears in a particular region, that is, in an (A) region where the bonding energy is 725 to 730 eV. This indicates that iron silicide (FeSi) has been formed.

In the case of (c), i.e., when a TiN layer having a sufficient thickness is formed between silicon and iron, iron silicide is not formed between the iron and the silicon since the TiN layer acts as a diffusion barrier that blocks the diffusion between the iron and the silicon. This demonstrates that iron silicide is formed by the diffusion of iron and silicon.

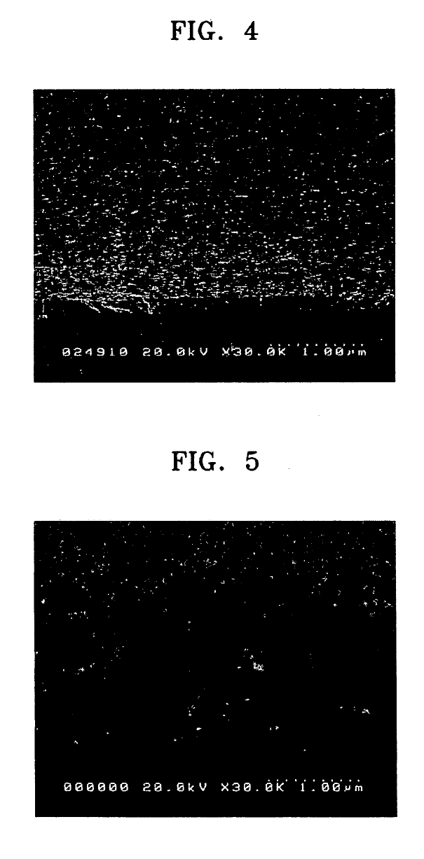

FIG. 4 is a SEM image showing that carbon nanotubes are not grown using a CVD method when a diffusion barrier is not included between a catalyst metal layer and a silicon layer. As described above, FIG. 4 shows that no carbon nanotubes are grown on the surface of the catalyst metal since iron is silicified. FIG. 5 is a SEM image of carbon nanotubes grown using a CVD method without annealing when a diffusion barrier is included between a catalyst metal layer and a silicon layer. Iron silicide is not formed on the catalyst metal layer since the diffusion barrier blocks the diffusion of materials between the catalyst metal layer and the silicon layer. As a result, dense carbon nanotubes are formed.

As shown in FIGS. 3 through 5, when diffusion occurs between a silicon layer and a catalyst metal layer, carbon nanotubes cannot grow on the catalyst metal layer since the catalyst metal layer is silicified, and when a buffer layer, i.e., a buffer layer which is a diffusion barrier is placed between the silicon layer and the catalyst metal layer, the buffer layer can block or control the diffusion of materials.

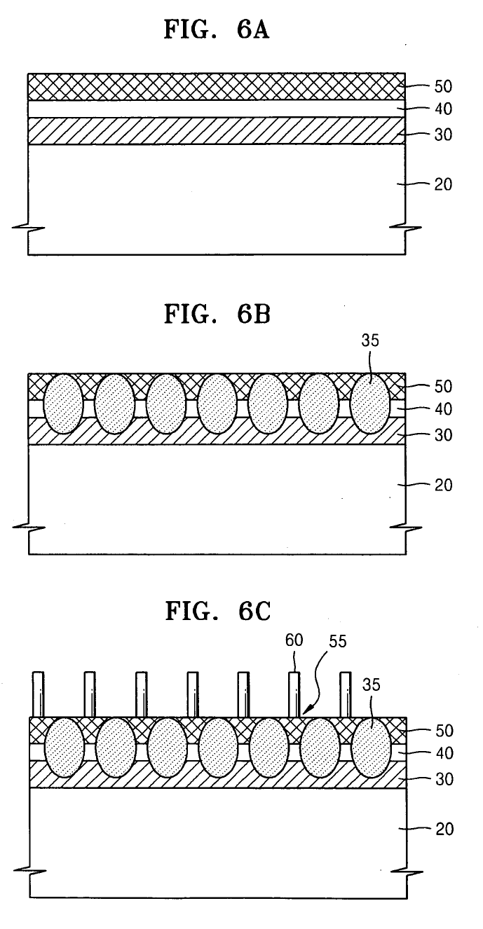

FIGS. 6A through 6C are cross-sectional views of a method of growing carbon nanotubes by diffusion control according to an embodiment of the present invention. As depicted in FIG. 6A, a substrate 20 having a silicon layer 30 on an upper surface thereof is provided, and a buffer layer 40 and a catalyst metal layer 50 are sequentially formed on the silicon layer 30. The substrate 20 can be formed of any material, such as glass, metal, etc., having properties sufficient to withstand deformation in a CVD process.

The silicon layer 30 can be formed of amorphous silicon, crystalline silicon, or other types of silicon. When the substrate 20 is a silicon wafer, an additional silicon layer may not necessary.

The buffer layer 40 is formed on the silicon layer 30. The buffer layer 40 can be formed by depositing a metal such as Ti, TiN, Al, Cr, Nb, or Cu, or an alloy of these metals on a surface of the silicon layer 30. The buffer layer 40 called as a diffusion barrier since it blocks diffusion of materials at high temperatures, that is, it blocks or mitigates material migration by diffusion between the silicon layer 30 and the catalyst metal layer 50. The buffer layer 40 when it is formed to a proper thickness can control the inter-layer material diffusion.

The catalyst metal layer 50 is formed on the buffer layer 40. The catalyst metal layer 50 can be formed by depositing a metal such as Ni, Fe, Co, Pt, Mo, W, Y, Au, or Pd, or an alloy of these metals on a surface of the buffer layer 40. The catalyst metal layer 50 allows carbon nanotubes to grow on a surface thereof when the carbon nanotubes are grown using a CVD method.

The buffer layer 40 and the catalyst metal layer 50 can be formed using a magnetron sputtering method or an electron beam evaporation method.

After the buffer layer 40 and the catalyst metal layer 50 have been formed on the silicon layer 30, the substrate 20 having the silicon layer 30, the buffer layer 40, and the catalyst metal layer 50 are annealed. The annealing can be performed using a radiation heating method, for example, using an infrared ray heater, under a vacuum atmosphere. The annealing temperature and time are determined by the thermal resistance of the substrate, the thickness of the catalyst metal layer 50 and the buffer layer 40, and the desired density of carbon nanotubes to be obtained. The annealing time can be determined in consideration of the above mentioned limiting factors, but if the annealing temperature is high, the annealing time can be reduced, and if the annealing temperature is low, the annealing time can be increased. Either way, an almost identical result can be obtained.

Through the annealing process, as depicted in FIG. 6B, a silicide domain 35 of a catalyst metal is partially formed by the diffusion between the silicon layer 30 and the catalyst metal layer 50. The silicide domain 35 of a catalyst metal can be uniformly formed on the entire surface of the catalyst metal layer 50 if the same annealing conditions are applied to the entire surface, and, as the annealing temperature and time increases in a particular region, the grown rate in that particular region increases. Accordingly, the silicide domain 35 in a specific region can be grown by heating the specific region. On the contrary, the silicide domain 35 in the specific region may not be grown by not heating the specific region.

After the annealing process, as depicted in FIG. 6C, carbon nanotubes are grown on the substrate 20 using a CVD method. The carbon nanotubes can also be grown using a thermal CVD method or a PECVD method. The method of growing the carbon nanotubes according to the present embodiment is not limited to a specific method, but can be any method by which carbon nanotubes can grow on the surface of a catalyst metal.

As an example, when a thermal CVD method is used, carbon nanotubes 60 are vertically grown from the surface of the catalyst metal layer 50 when a carbon containing gas, such as CH₄, C₂H₂, C₂H₄, C₂H₆, CO, or CO₂, is injected together with H₂, N₂, or Ar into a reactor, a temperature of which is set at 500 to 900° C.

However, as described above, the carbon nanotubes 60 are not grown on the surface of the silicide domain 35 of a catalyst metal, but are grown only on regions 55 outside of the silicide domain 35. Accordingly, the carbon nanotubes 60 can be arranges at predetermined distances according to the degree of silicification of the catalyst metal layer 50. Also, when the regions for forming the silicide domain 35 are appropriately controlled, the carbon nanotubes 60 can be suitably arranged on required regions.

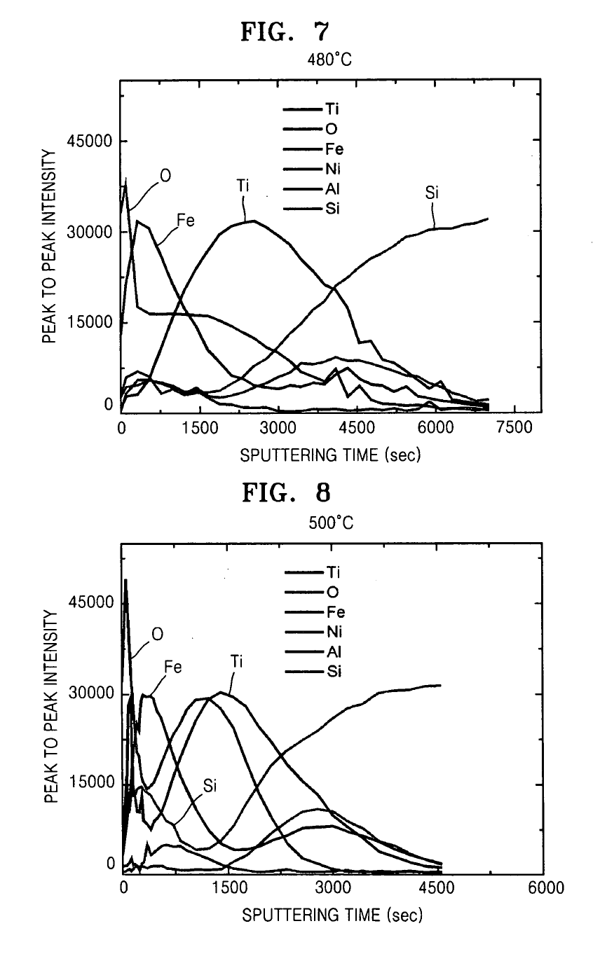

FIGS. 7 and 8 are graphs of component distributions according to the depth from the surface of a substrate respectively annealed at temperatures of 480° C. and 500° C. while sputtering. When the graphs in FIG. 7 and the graphs in FIG. 8 are compared, it is noted that silicon (Si) is distributed close to the surface of the substrate. This indicates that, as described above, silicon silicifies Fe, Ni, etc. included in an invar, i.e., the catalyst metal layer by diffusing through a buffer layer.

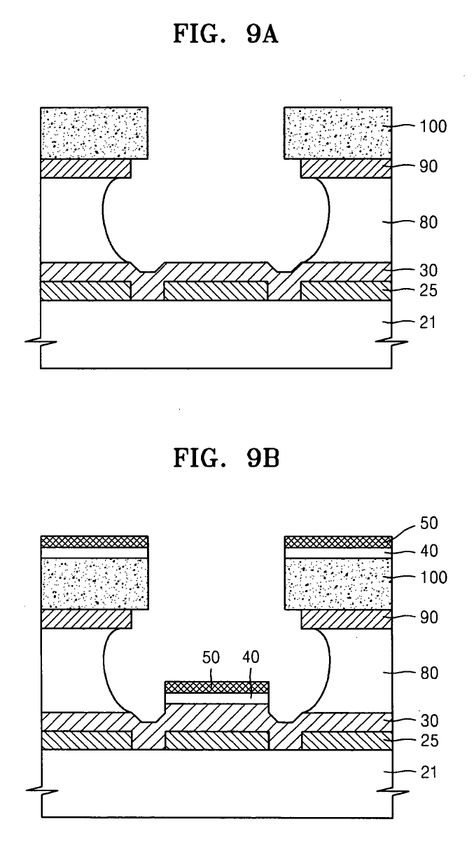

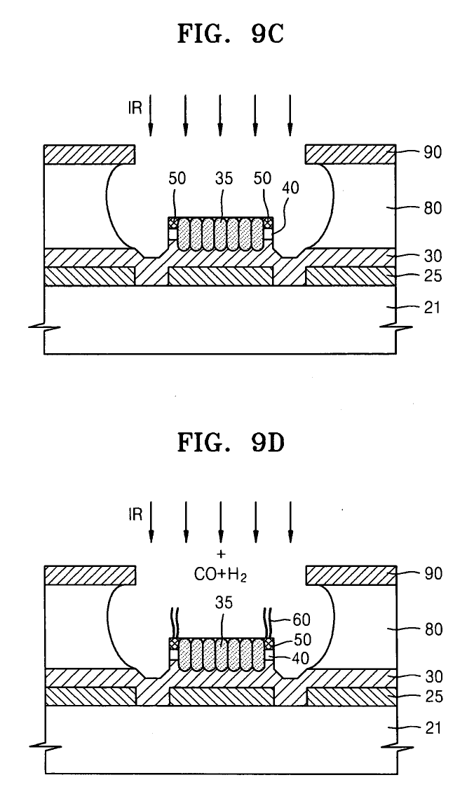

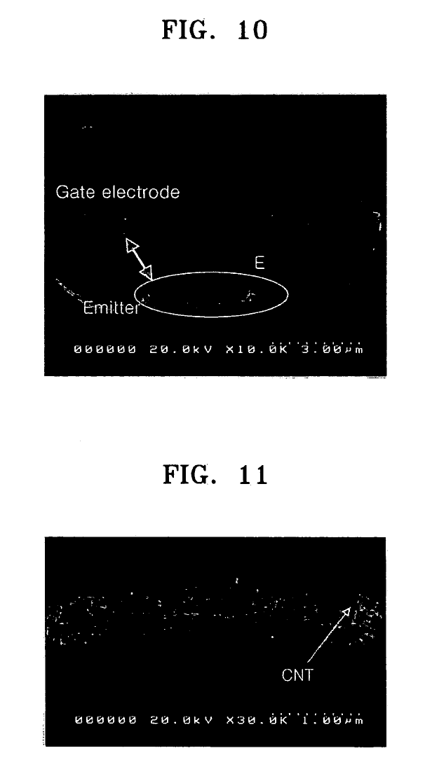

FIGS. 9A through 9D are cross-sectional views of a method of manufacturing an FED according to an embodiment of the present invention. Referring to FIG. 9A, a cathode 25, a silicon layer 30, a gate insulating layer 80, and a gate electrode 90 are sequentially formed on an upper surface of a rear substrate 21. For example, an Indium Tin Oxide (ITO) electrode can be patterned on an upper surface of the rear substrate 21, and an amorphous silicon (a-Si) layer 30 can be formed on the patterned ITO electrode. However, the silicon layer 30, as described above, can be formed before a well is formed in the gate electrode 90 and the gate insulating layer 80, or the silicon layer 30 can be formed before stacking a buffer layer but after the well has been formed.

The gate insulating layer 80 is formed on the silicon layer 30 using an insulating material such as silicon dioxide (SiO₂), and, after depositing a metal, such as chrome Cr, on the gate insulating layer 80, the gate electrode 90 is formed by patterning the metal. Also, the well is formed on a predetermined region of the silicon layer 30 through the gate insulating layer 80 and the gate electrode 90 to expose the silicon layer 30 on the bottom of the well.

Next, referring to FIG. 9B, an emitter block is formed by depositing materials that form a buffer layer 40 and a catalyst metal layer 50. To selectively deposit materials for forming the buffer layer 40 and the catalyst metal layer 50 on the surface of the silicon layer 30, a photo-resist lift-off method can be used. The deposition method can be a magnetron sputtering method or an electron beam evaporation method.

Next, as a feature process of the present invention, the rear substrate 21, on which the buffer layer 40 and the catalyst metal layer 50 are formed, is annealed. The rear substrate 21 is annealed at a temperature that does not cause deformation of the rear substrate 21 to promote diffusion between the silicon layer 30 and the catalyst metal layer 50, and accordingly, to partly form catalyst metal silicide domains on the catalyst metal layer 50.

The annealing can be performed in a vacuum atmosphere using a radiation heating method such as an infrared ray heating method. However, a heating method such as a thermal CVD method can be used for simplifying process and reducing additional costs. For example, the infrared ray heating method can be commonly used for annealing and thermal CVD. When the upper surface of the rear substrate 21 is heated using the infrared ray heating method, the catalyst metal silicide domains are formed on the catalyst metal layer 50.

As a characteristic of the radiation heating method, a region where the radiation heating rays cannot reach can be arranged on an edge of the emitter block since the radiation heating rays are blocked by the gate electrode 90. Also, the silicidation of the catalyst metal layer 50 occurs less on an edge region of the catalyst metal layer 50 due to heat being easily dissipated through sides of the emitter block, for example. FIG. 9C is a cross-sectional view of the silicide domain 35 of a catalyst metal formed through annealing.

To form the silicide domain 35 of a catalyst metal only on the central portion of the emitter block except for edge regions thereof, the catalyst metal layer 50 can be formed to a thickness of 0.5 to 10 nm and the buffer layer 40 can be formed to a thickness of 1 to 10 nm. When the catalyst metal layer 50 and the buffer layer 40 are too thin, the degree of diffusion cannot be controlled, and when they are too thick, silicon cannot diffuse to the surface of the catalyst metal layer 50.

Also, the annealing can be performed using various combinations of temperature selected from a range of 450 to 500° C. and time selected from a range of 5 to 60 minutes. However, according to the present embodiment, in consideration of manufacturing efficiency, the annealing can be performed at a temperature of approximately 480° C. for 10 to 18 minutes. Almost the same result can be obtained if the annealing is performed at a temperature lower than 450° C. for a longer time than 60 minutes and at a temperature higher than 500° C. for a shorter time than 5 minutes.

Next, referring to FIG. 9D, carbon nanotubes 60 are grown on the surface of the catalyst metal layer 50 where the catalyst metal silicide domains 35 of a catalyst metal have been formed. To grow the carbon nanotubes 60, the thermal CVD method that uses the infrared ray heating method can also be used as in the annealing process, but the present invention is not limited thereto. As depicted in FIG. 9D, the carbon nanotubes 60 start to grow from regions of the surface of the catalyst metal layer 50 except for the region where the silicide domain 35 are formed, that is, they start to grow from edge regions of the emitter block. The carbon nanotubes 60 are located at approximately uniform distances from an edge of the gate electrode 90. Therefore, electron beams emitted from the carbon nanotubes 60 generally have uniform characteristics.

FIG. 10 is a SEM image of a cut-away FED according to an embodiment of the present invention. Carbon nanotubes are arranged in a ring shape on an upper surface of the emitter block and are located at approximately uniform distances from the gate electrode. FIG. 11 is a magnified SEM image of a region E of FIG. 10. The carbon nanotubes are not grown on a central portion of the ring-shaped emitter, but grown on edge regions thereof.

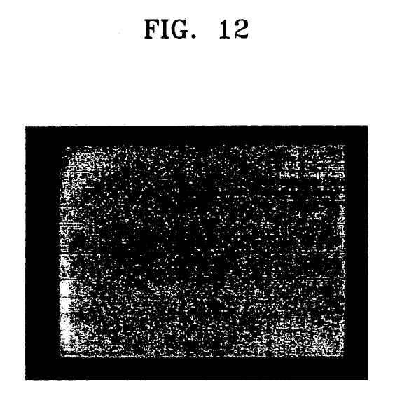

FIG. 12 is a photograph of a uniformity test of a flat panel display device that uses an FED according to an embodiment of the present invention. The test conditions were as follows. An anode voltage of 500V and a gate electrode voltage of 100V were supplied, a discharge current was 65 μA, and the size of the flat panel display device was 5 inches.

An FED according to the present invention has a ring-shaped emitter in which carbon nanotubes are formed only on edge regions of the emitter due to the aforementioned configuration. Therefore, the distance between the carbon nanotubes and a gate electrode is uniform. Accordingly, electron beams emitted from the carbon nanotubes can be easily controlled.

Also, in the present invention, a buffer layer and a silicon layer are provided under a catalyst metal layer that forms the emitter surface to control the diffusion between the catalyst metal layer and the silicon layer. Therefore, an FED having an emitter in which carbon nanotubes are grown in a ring shape can be readily manufactured using an existing process with an addition of a simple annealing process thereto.

While the present invention has been particularly shown and described with reference to exemplary embodiments thereof, it will be understood by those of ordinary skill in the art that various modifications in form and detail can be made therein without departing from the spirit and scope of the present invention as defined by the following claims.

What is claimed is:

1. A Field Emission Device (FED), comprising:
a ring-shaped emitter;
a front substrate and a rear substrate;
an anode arranged on a lower surface of the front substrate; and
a cathode and a gate electrode arranged on an upper surface of the rear substrate;
wherein the ring-shaped emitter, arranged on a portion of the cathode exposed by an aperture of the gate electrode, has a shape corresponding to a shape of the aperture of the gate electrode and has carbon nanotubes arranged on edges thereof.

2. The FED of claim 1, wherein the aperture of the gate electrode and the ring-shaped emitter are concentric.

3. The FED of claim 1, wherein the ring-shaped emitter comprises a silicon layer, a buffer layer, and a catalyst metal layer sequentially stacked on the cathode, and catalyst metal silicide domains arranged on a central portion of the catalyst metal layer by diffusion between the silicon layer and the catalyst metal layer.

4. The FED of claim 3, wherein the catalyst metal layer comprises at least one metal or an alloy thereof selected from a group of metals consisting of Ni, Fe, Co, Pt, Mo, W, Y, Au, and Pd.

5. The FED of claim 3, wherein the buffer layer comprises at least one metal or an alloy thereof selected from a group of metals consisting of Ti, TiN, Al, Cr, Nb, and Cu.

6. The FED of claim 3, wherein the silicon layer comprises amorphous silicon.

7. A method of manufacturing a Field Emission Device (FED) having a ring-shaped emitter, the method comprising:
forming a cathode having a silicon layer on an upper surface thereof, a gate insulating layer covering the cathode, and a gate electrode covering the gate insulating layer on a rear substrate;
forming a well in the gate electrode and the gate insulating layer to expose the silicon layer;
forming an emitter block having a shape corresponding to a shape of the aperture of the gate electrode on the silicon layer in the well by sequentially stacking a buffer layer and a catalyst metal layer on the silicon layer exposed in the well;
forming catalyst metal silicide domains on a central portion of the emitter block by annealing the rear substrate using a radiation heater to promote diffusion between the silicon layer and the catalyst metal layer; and
forming a ring-shaped carbon nanotube emitter by growing carbon nanotubes on edges of an upper surface of the emitter block.

8. The method of claim 7, wherein the silicon layer is formed of amorphous silicon.

9. The method of claim 7, wherein the catalyst metal layer is formed of at least one metal or an alloy thereof selected from a group of metals consisting of Ni, Fe, Co, Pt, Mo, W, Y, Au, and Pd.

10. The method of claim 7, wherein the catalyst metal layer is formed to have a thickness in a range of 0.5 to 10 nm.

11. The method of claim 7, wherein the buffer layer is formed of at least one metal or an alloy thereof selected from a group of metals consisting of Ti, TiN, Al, Cr, Nb, and Cu.

12. The method of claim 11, wherein the buffer layer is formed to have a thickness in a range of 1 to 10 nm.

13. The method of claim 7, wherein the buffer layer and the catalyst metal layer are formed by either a magnetron sputtering method or an electron beam evaporation method.

14. The method of claim 7, wherein the annealing is performed by an infrared ray heating method in a vacuum atmosphere.

15. The method of claim 7, wherein the annealing is performed at a temperature in a range of 450 to 500° C. for a time period in a range of 5 to 60 minutes.

16. The method of claim 7, wherein the catalyst metal layer is formed of at least one metal or an alloy thereof selected from a group of metals consisting of Ni, Fe, Co, Pt, Mo, W, Y, Au, and Pd;
wherein the catalyst metal layer has a thickness in a range of 0.5 to 10 nm;
wherein the buffer layer is formed of at least one metal or an alloy thereof selected from a group of metals consisting of Ti, TiN, Al, Cr, Nb, and Cu;
wherein the buffer layer has a thickness in a range of 1 to 10 nm; and
wherein the annealing is performed at a temperature in a of range 450 to 500° C. for a time period in a range of 5 to 60 minutes.

17. The method of claim 7, wherein the carbon nanotubes are grown by either a thermal Chemical Vapor Deposition (CVD) method or a plasma enhanced CVD method.

18. The method of claim 17, wherein the carbon nanotubes are grown by an infrared ray heating method.
